(19) United States
(12) Patent Application Publication
(10) Pub. No.: US 2025/0336606 A1
(43) Pub. Date: Oct. 30, 2025

(54) MULTILAYER ELECTRONIC COMPONENT AND MOUNTING STRUCTURE FOR MULTILAYER ELECTRONIC COMPONENT

(71) Applicant: Murata Manufacturing Co., Ltd., Nagaokakyo-shi (JP)

(72) Inventor: Kazunori USUI, Nagaokakyo-shi (JP)

(21) Appl. No.: 19/262,553

(22) Filed: Jul. 8, 2025

Related U.S. Application Data
(63) Continuation of application No. PCT/JP2024/012775, filed on Mar. 28, 2024.

(30) Foreign Application Priority Data
May 17, 2023 (JP) 2023-081594

(51) Int. Cl. H01G 4/232; H01G 2/06; H01G 4/005; H01G 4/12; H01G 4/248; H01G 4/30; H01G 13/00

(52) U.S. Cl. CPC H01G 4/2325; H01G 2/065; H01G 4/005; H01G 4/12; H01G 4/248; H01G 4/30; H01G 13/006

(57) ABSTRACT

A multilayer ceramic capacitor includes a multilayer body including a first surface and a second surface opposite each other, a third surface and a fourth surface opposite each other, and a fifth surface and a sixth surface opposite each other. The outer electrode is located on the fifth surface of the multilayer body. An outer electrode includes a base electrode layer on the fifth surface and connected to an inner electrode of the multilayer body, an Sn—Cu diffusion layer on the base electrode layer and including tin and copper, an Sn—Ni diffusion layer on an outer side of the Sn—Cu diffusion layer and including tin and nickel, and an Ni plating layer on the Sn—Ni diffusion layer and including nickel as a main component. A gap is located at an interface between the base electrode layer and the Sn—Cu diffusion layer.

### CROSS REFERENCE TO RELATED APPLICATIONS

This application claims the benefit of priority to Japanese Patent Application No. 2023-081594 filed on May 17, 2023 and is a Continuation application of PCT Application No. PCT/JP2024/012775 filed on Mar. 28, 2024. The entire contents of each application are hereby incorporated herein by reference.

### BACKGROUND OF THE INVENTION

### 1. Field of the Invention

The present disclosure relates to multilayer electronic components and mounting structures for multilayer electronic components.

### 2. Description of the Related Art

In recent years, improvement in the reliability of multilayer ceramic capacitors for electronic components and multilayer ceramic capacitors for car-mounted applications is desired.

For example, in the multilayer ceramic capacitor described in Japanese Unexamined Patent Application Publication No. 2022-119088, inner electrode layers are placed inside a multilayer chip that includes dielectric layers including ceramic material that functions as a dielectric. The inner electrode layers are exposed at the surface of the multilayer chip, and outer electrodes are placed so as to be joined to the inner electrode layers. A plating layer including metal, such as copper (Cu), nickel (Ni), and tin (Sn), as a main component is provided on each of the surfaces of the outer electrodes.

Japanese Unexamined Patent Application Publication No. 01-080011 describes that hydrogen generated by a chemical reaction during a plating layer formation process is absorbed into inner electrodes, and the absorbed hydrogen gradually reduces dielectric layers around the inner electrodes to deteriorate insulation resistance.

### SUMMARY OF THE INVENTION

Example embodiments of the present invention reduce or prevent deterioration of insulation resistance in a multilayer electronic component.

A multilayer electronic component according to an example embodiment of the present disclosure includes a multilayer body including a first surface and a second surface opposite each other in a lamination direction, a third surface and a fourth surface opposite each other in a first direction orthogonal to the lamination direction, and a fifth surface and a sixth surface opposite each other in a second direction orthogonal to the lamination direction and the first direction, a first outer electrode on the fifth surface of the multilayer body, and a second outer electrode on the sixth surface of the multilayer body. The multilayer body includes an inner dielectric layer and an inner electrode laminated on the inner dielectric layer in the lamination direction and including an end portion located at the fifth surface. The first outer electrode includes a base electrode layer on the fifth surface and connected to the inner electrode, an Sn—Cu diffusion layer on the base electrode layer and including tin and copper, an Sn—Ni diffusion layer on an outer side of the Sn—Cu diffusion layer and including tin and nickel, and an Ni plating layer on the Sn—Ni diffusion layer and including nickel as a main component. A gap is located at an interface between the base electrode layer and the Sn—Cu diffusion layer.

According to example embodiments of the present disclosure, it is possible to reduce or prevent the deterioration of insulation resistance in a multilayer electronic component.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to a first example embodiment of the present invention.

FIG. 2 is a cross-sectional view taken along the line II-II in FIG. 1.

FIG. 3 is a cross-sectional view taken along the line III-III in FIG. 1.

FIG. 4 is an exploded perspective view of an inner layer portion according to the first example embodiment of the present invention.

FIG. 5 is an enlarged view of a region R in FIG. 2.

FIG. 6 is a perspective view of a multilayer ceramic capacitor according to a second example embodiment of the present invention.

FIG. 7 is a cross-sectional view taken along the line VII-VII in FIG. 6.

FIG. 8 is a cross-sectional view taken along the line VIII-VIII in FIG. 6.

FIG. 9 is a cross-sectional view taken along the line IX-IX in FIG. 8.

FIG. 10 is a cross-sectional view taken along the line X-X in FIG. 8.

FIG. 11 is an enlarged view of a region R1 in FIG. 7.

FIG. 12 is an enlarged view of a region R2 in FIG. 8.

FIG. 13 is a perspective view of a mounting structure for the multilayer ceramic capacitor according to the second example embodiment of the present invention.

FIG. 14 is a cross-sectional view taken along the line XIV-XIV in FIG. 13.

FIG. 15 is a cross-sectional view taken along the line XV-XV in FIG. 13.

FIG. 16 is a flowchart for illustrating a manufacturing method for the multilayer ceramic capacitor according to the first example embodiment of the present invention.

### DETAILED DESCRIPTION OF THE EXAMPLE EMBODIMENTS

Hereinafter, example embodiments of the present disclosure will be described with reference to the drawings.

The example embodiments are some of the example embodiments of the present disclosure, and the present disclosure is not limited to the details of those example embodiments. Combinations of the details described in different example embodiments can also be implemented, and the details of those combinations are also included in the present disclosure. The drawings are intended to help understand the specification, and can be drawn schematically. The ratios of dimensions of the drawn components or dimensions between the components sometimes do not correspond to the ratios of dimensions of those described in the specification. The components described in the specification can be, for example, not shown in the drawings or drawn in less number.

### 1. Multilayer Ceramic Capacitor

### First Example Embodiment

A multilayer ceramic capacitor according to the first example embodiment of the present disclosure will be described.

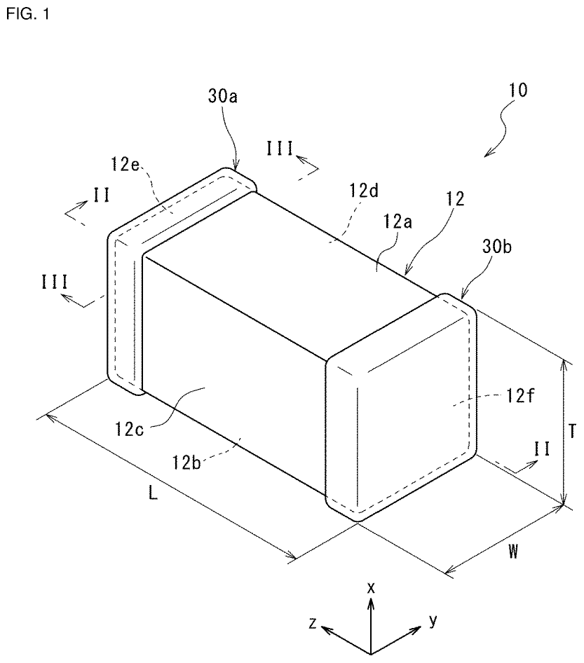

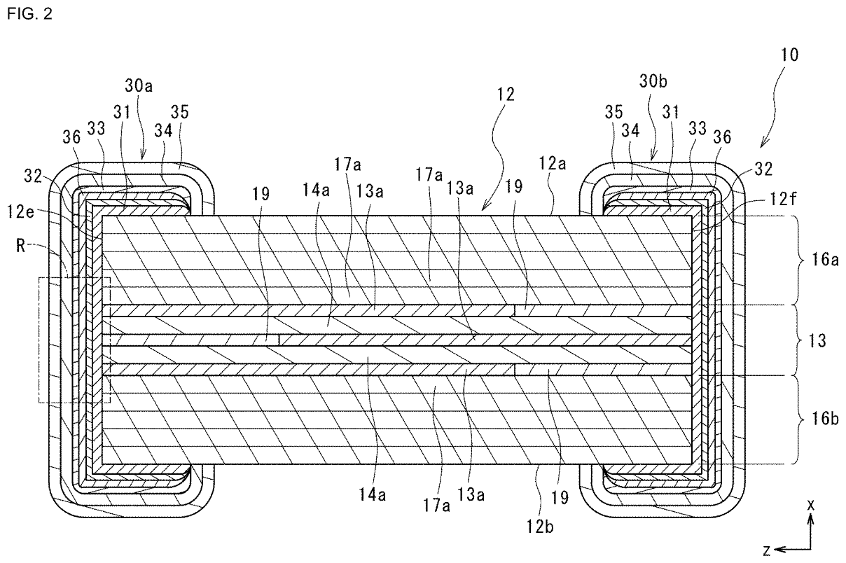

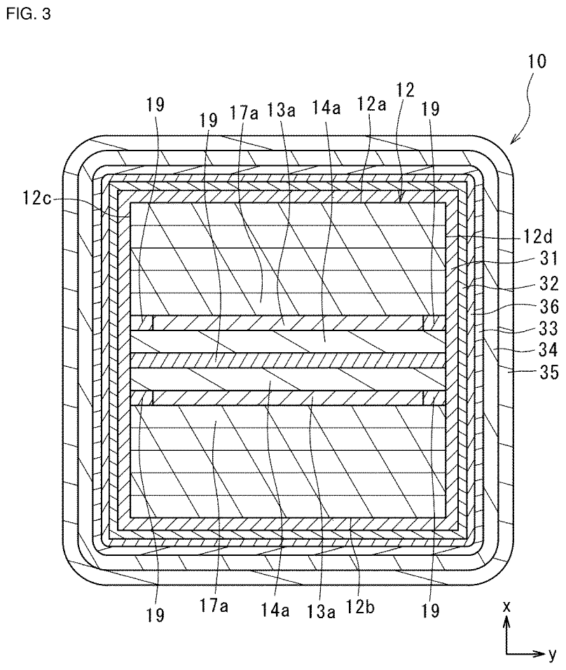

FIG. 1 is a perspective view that shows an example of the multilayer ceramic capacitor according to the first example embodiment of the present disclosure. FIG. 2 is a cross-sectional view taken along the line II-II in FIG. 1. FIG. 3 is a cross-sectional view taken along the line III-III in FIG. 1.

The drawings may indicate a lamination direction X, a width direction Y, and a length direction Z of the multilayer ceramic capacitor 10, and these directions may be referred to in the following description. The width direction Y of the present example embodiment is an example of a first direction, and the length direction Z is an example of a second direction. The width direction Y of the present example embodiment may also be an example of a second direction, and the length direction Z may also be an example of a first direction.

Referring to FIG. 1, the multilayer ceramic capacitor 10 includes a multilayer body 12, a first outer electrode 30a, and a second outer electrode 30b. In the following description, if there is no need to specifically distinguish the first outer electrode 30a and the second outer electrode 30b from each other, one of them may simply be referred to as outer electrode 30. The multilayer ceramic capacitor 10 according to the present example embodiment is an example of the multilayer electronic component.

The multilayer body 12 of the present example embodiment has a rectangular parallelepiped shape or a substantially rectangular parallelepiped shape as a whole. The multilayer body 12 includes a first surface 12a and a second surface 12b opposite each other in the lamination direction X, a third surface 12c and a fourth surface 12d opposite each other in the width direction Y, and a fifth surface 12e and a sixth surface 12f opposite each other in the length direction Z. In the present example embodiment, the lamination direction X, the width direction Y, and the length direction Z are orthogonal to one another. In the multilayer body 12, corner portions and ridge portions are desirably rounded. The corner portions refer to the parts where three adjacent sides of the multilayer body 12 intersect. The ridge portions refer to the portions where two adjacent sides of the multilayer body 12 intersect. One or some or all of the pair of first surface 12a and second surface 12b, the pair of third surface 12c and fourth surface 12d, and the pair of fifth surface 12e and sixth surface 12f may include irregularities or the like.

As shown in FIGS. 2 and 3, the multilayer body 12 includes an inner layer portion 13, a first outer layer portion 16a, and a second outer layer portion 16b. In the following description, the first outer layer portion 16a and the second outer layer portion 16b may simply be referred to as outer layer portion 16.

### Inner Layer Portion 13

The inner layer portion 13 includes a plurality of inner electrodes 13a and a plurality of inner dielectric layers 14a. The inner layer portion 13 is a portion located between the inner electrode 13a closest to the first outer layer portion 16a among the plurality of inner electrodes 13a and the inner electrode 13a closest to the second outer layer portion 16b among the plurality of inner electrodes 13a. In other words, the inner layer portion 13 is a portion located between the inner electrode 13a adjacent to the first outer layer portion 16a and the inner electrode 13a adjacent to the second outer layer portion 16b.

The plurality of inner dielectric layers 14a is laminated in the lamination direction X. The material of each inner dielectric layer 14a is optional. For example, a dielectric ceramic including barium titanate (BaTiO₃) as a main component can be used as the material for the inner dielectric layer 14a. In particular, the material of the inner dielectric layer 14a may have a plurality of crystal grains including a perovskite-type compound with BaTiO₃ as a basic structure. However, instead of BaTiO₃, a dielectric ceramic with a different compound as a main component, such as calcium titanate (CaTiO₃), strontium titanate (SrTiO₃), and calcium zirconate (CaZrO₃), may be used as the material of the inner dielectric layer 14a. A main component, such as BaTiO₃, CaTiO₃, SrTiO₃, and CaZrO₃, added with a compound, such as a manganese (Mn) compound, an iron (Fe) compound, a chromium (Cr) compound, a cobalt (Co) compound, and a nickel (Ni) compound, as a secondary component, in a smaller content range than the main component, may be used as the material of the inner dielectric layer 14a. The thickness, that is, the dimension in the lamination direction X, of the inner dielectric layer 14a is optional and is preferably less than or equal to about 10.0 μm, for example.

Each inner electrode 13a is provided between two adjacent dielectric layers in the lamination direction X among the plurality of dielectric layers included in the multilayer body 12. The inner electrode 13a may be between two adjacent inner dielectric layers 14a in the lamination direction X among the plurality of inner dielectric layers 14a. The inner electrode 13a may be between the inner dielectric layer 14a and an outer dielectric layer 17a of the outer layer portion 16, which are adjacent to each other in the lamination direction X. The inner dielectric layer 14a is between the two adjacent inner electrodes 13a in the lamination direction X. The inner electrode 13a is in contact with the inner dielectric layer 14a.

The inner electrode 13a of 41 the present example embodiment is a plate-shaped electrode. The inner electrode 13a extends in the length direction Z. The inner electrode 13a includes a first end exposed at any one of the fifth surface 12e and the sixth surface 12f, and a second end located inside the multilayer body 12.

Referring to FIG. 2, in the present example embodiment, each inner electrode 13a is exposed at any one of the fifth surface 12e and the sixth surface 12f of the multilayer body 12. The plurality of inner electrodes 13a includes the inner electrodes 13a exposed at the fifth surface 12e and not exposed at the sixth surface 12f, and the inner electrodes 13a exposed at the sixth surface 12f and not exposed at the fifth surface 12e. The inner electrodes 13a exposed at the fifth surface 12e and not exposed at the sixth surface 12f and the inner electrodes 13a exposed at the sixth surface 12f and not exposed at the fifth surface 12e are located alternately in the lamination direction X.

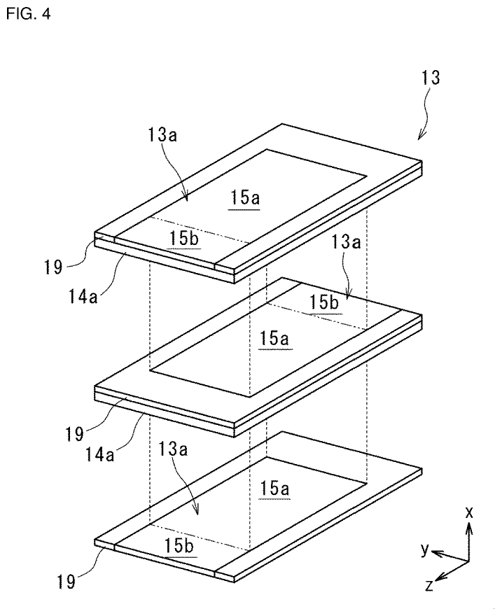

FIG. 4 is an exploded perspective view of the inner layer portion 13. Referring to FIG. 4, each inner electrode 13a includes a counter electrode portion 15a and an extended electrode portion 15b. The counter electrode portion 15a is a portion that surfaces other adjacent inner electrodes 13a in the lamination direction X among the inner electrodes 13a. The extended electrode portion 15b is a portion of the inner electrode 13a other than the counter electrode portion 15a. A capacitance is generated such that the counter electrode portions 15a of the two adjacent inner electrodes 13a in the lamination direction X surface each other with the inner dielectric layer 14a interposed therebetween. Each extended electrode portion 15b is exposed at any one of the fifth surface 12e and the sixth surface 12f.

The shape of the inner electrode 13a is not particularly limited. However, the shape of the inner electrode 13a is preferably rectangular when viewed in the lamination direction X. The corner portions of the counter electrode portions 15a may be chamfered or rounded. The corner portions of the extended electrode portions 15b may be chamfered or rounded.

The inner electrode 13a preferably has a uniform thickness, that is, dimension in the lamination direction X, along the width direction Y. The thickness of the inner electrode 13a at the end portion in the width direction Y may be thicker than the thickness of the inner electrode 13a at a center portion in the width direction Y.

In the present example embodiment, the main component of the inner electrode 13a is copper (Cu). However, the main component of the inner electrode 13a is optional and may be another metal, such as Ni, palladium (Pd), and silver (Ag), instead of Cu. The main component of the inner electrode 13a may be an alloy of Ni, Pd, Ag, Cu, or the like with another metal.

The thickness of the inner electrode 13a is optional. However, the thickness of the inner electrode 13a is preferably, for example, greater than or equal to about 0.2 μm and less than or equal to about 2.0 μm.

### Outer Layer Portion 16

Referring to FIGS. 2 and 3, the first outer layer portion 16a and the second outer layer portion 16b are respectively provided on both sides of the inner layer portion 13 in the lamination direction X. The first outer layer portion 16a is provided on one side (upper side in FIGS. 2 and 3) of the inner layer portion 13 in the lamination direction X. In other words, the first outer layer portion 16a is provided on the first surface 12a side of the inner layer portion 13. The second outer layer portion 16b is provided on the other side (lower side in FIGS. 2 and 3) of the inner layer portion 13 in the lamination direction X. In other words, the second outer layer portion 16b may be provided on the second surface 12b side of the inner layer portion 13.

The outer layer portion 16 includes a plurality of outer dielectric layers 17a. The plurality of outer dielectric layers 17a is laminated in the lamination direction X. The material of each outer dielectric layer 17a is optional. For example, a dielectric ceramic including BaTiO₃ as a main component can be used as the material of the outer dielectric layer 17a. However, instead of BaTiO₃, a dielectric ceramic including another compound, such as CaTiO₃, SrTiO₃, or CaZro₃, as a main component may be used as the material of the outer dielectric layer 17a. A main component, such as BaTiO₃, CaTiO₃, SrTiO₃, or CaZrO₃, added with a compound, such as an Mn compound, an Fe compound, a Cr compound, a Co compound, or an Ni compound, as a secondary component, in a smaller content range than the main component may be used. The material of the outer dielectric layer 17a may be made of a main component different from the material of the inner dielectric layer 14a.

Although not shown in the drawings, an electrically insulating layer may be provided on each of the third surface 12c and the fourth surface 12d of the multilayer body 12. When the electrically insulating layers are provided, it is possible to reduce the entry of moisture to the interfaces between the inner electrodes 13a and the inner dielectric layers 14a, the interfaces between the inner electrodes 13a and the outer dielectric layers 17a, and the inside of the multilayer body 12. The electrically insulating layer preferably includes the or similar same components as the inner dielectric layer 14a or the outer dielectric layer 17a. When the electrically insulating layer includes the same or similar components as the inner dielectric layer 14a, the adhesion between the electrically insulating layers and the inner dielectric layers 14a is improved. When the electrically insulating layer includes the same or similar components as the outer dielectric layer 17a, the adhesion between the electrically insulating layers and the outer dielectric layers 17a is improved.

The electrically insulating layers may also be joined to the inner electrodes 13a. In this case, the surfaces of the electrically insulating layers on the sides not joined to the inner electrodes 13a become the third surface 12c and the fourth surface 12d. In other words, when the electrically insulating layers are joined to the inner electrodes 13a, the surfaces of the electrically insulating layers, on the opposite sides from the inner electrodes 13a make up the third surface 12c and the fourth surface 12d of the multilayer body 12.

Each of the electrically insulating layers preferably includes an innermost inner layer in the width direction Y and an outermost outer layer in the width direction Y. Providing the inner layer and the outer layer makes it possible to easily find a boundary through observation with an optical microscope based on the difference in degree of sintering between the inner layer and the outer layer. In other words, there is a boundary between the inner layer and the outer layer. A plurality of boundaries may be provided.

The electrically insulating layer is not limited to a two-layer structure and may also have a structure with three or more layers. When the electrically insulating layer includes three or more layers, the layer on the innermost side in the width direction Y is defined as the inner layer, and the layer on the outermost side in the width direction Y is defined as the outer layer.

A step layer 19 is provided in the same plane as a corresponding one of the inner electrodes 13a. When the step layer 19 is not provided, there is a difference in the thickness of the inner layer portion 13 between a portion where the inner electrode 13a is located and a portion where the inner electrode 13a is not provided, with the result that distortion occurs during pressing or the like in a manufacturing process for the multilayer ceramic capacitor 10 (described later), which may lead to structural defects. In contrast, in the present example embodiment, the step layer 19 can fill a step corresponding to the thickness of the inner electrode 13a in the lamination direction X, so it is possible to reduce or prevent distortion during pressing or the like in the manufacturing process for the multilayer ceramic capacitor 10 to reduce or prevent structural defects. The step layer 19 preferably has the same or substantially the same thickness as the inner electrode 13a in the same plane. The step layer 19 preferably includes the same or substantially the same components as the inner dielectric layer 14a.

### Outer Electrode 30

The first outer electrode 30a is provided on the fifth surface 12e side of the multilayer body 12. In the present example embodiment, the first outer electrode 30a is provided on the first surface 12a, the second surface 12b, the third surface 12c, the fourth surface 12d, and the fifth surface 12e. The first outer electrode 30a may be provided only on the fifth surface 12e of the multilayer body 12. However, the first outer electrode 30a is preferably continuously provided on the fifth surface 12e, the first surface 12a, and the second surface 12b. The first outer electrode 30a is more preferably provided additionally on the third surface 12c and the fourth surface 12d. The first outer electrode 30a is joined to the inner electrodes 13a exposed at the fifth surface 12e of the multilayer body 12. In this way, the first outer electrode 30a is electrically connected to the inner electrodes 13a located at the fifth surface 12e of the multilayer body 12.

The second outer electrode 30b is provided on the sixth surface 12f side of the multilayer body 12. In the present example embodiment, the second outer electrode 30b is provided on the first surface 12a, the second surface 12b, the third surface 12c, the fourth surface 12d, and the sixth surface 12f. The second outer electrode 30b may be provided only on the sixth surface 12f of the multilayer body 12. However, the second outer electrode 30b is preferably continuously provided on the sixth surface 12f, the first surface 12a, and the second surface 12b. The second outer electrode 30b is preferably provided additionally on the third surface 12c and the fourth surface 12d. The second outer electrode 30b is joined to the inner electrodes 13a exposed at the sixth surface 12f of the multilayer body 12. In this way, the second outer electrode 30b is electrically connected to the inner electrodes 13a provided at the sixth surface 12f of the multilayer body 12.

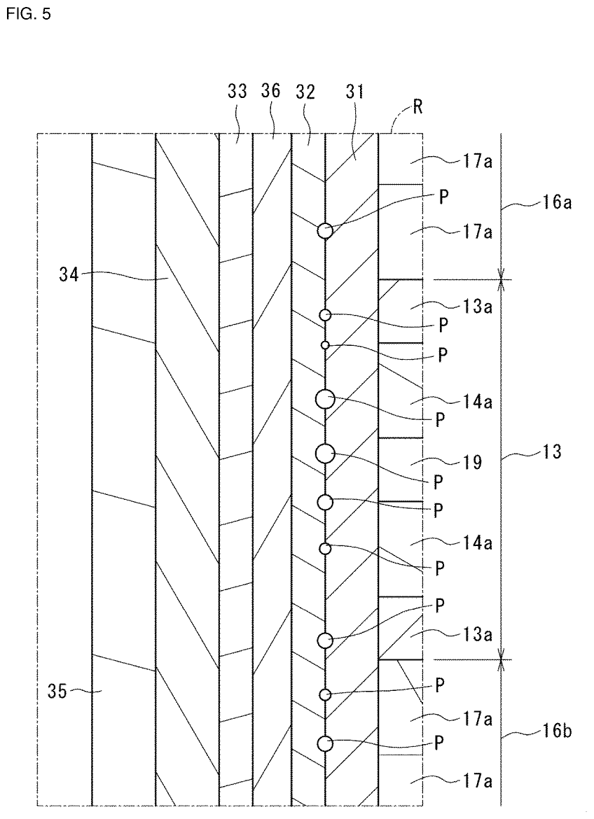

FIG. 5 is an enlarged view of a region R in FIG. 2. FIG. 5 shows a partially enlarged view of the first outer electrode 30a. The second outer electrode 30b also has a similar configuration to that of the first outer electrode 30a.

The outer electrode 30 includes a base electrode layer 31, an Sn—Cu diffusion layer 32 covering the base electrode layer 31, an Sn—Ni diffusion layer 33, an Ni plating layer 34, and an Sn plating layer 35, as shown in FIGS. 2, 3, and 5.

The base electrode layer 31 of the first outer electrode 30a is a sintered layer. The sintered layer includes glass components and metal. The glass components included in the sintered layer include at least one selected from among boron (B), silicon (Si), barium (Ba), magnesium (Mg), aluminum (Al), or lithium (Li). In the present example embodiment, at least one selected from among B, Ba, Mg, Al, or Li is added to silicon dioxide (SiO₂) as the glass components included in the sintered layer. The metal included in the sintered layer includes Cu.

The base electrode layer 31 of the first outer electrode 30a is provided on the fifth surface 12e side of the multilayer body 12. The base electrode layer 31 of the first outer electrode 30a of the present example embodiment is continuously provided on the first surface 12a, the second surface 12b, the third surface 12c, the fourth surface 12d, and the fifth surface 12e of the multilayer body 12. The base electrode layer 31 of the first outer electrode 30a is electrically connected to the inner electrodes 13a exposed at the fifth surface 12e.

The base electrode layer 31 of the second outer electrode 30b is provided on the sixth surface 12f side of the multilayer body 12. The base electrode layer 31 of the second outer electrode 30b of the present example embodiment is continuously provided on the first surface 12a, the second surface 12b, the third surface 12c, the fourth surface 12d, and the sixth surface 12f of the multilayer body 12. The base electrode layer 31 of the second outer electrode 30b is electrically connected to the inner electrodes 13a exposed at the sixth surface 12f.

The Sn—Cu diffusion layer 32 is provided on the base electrode layer 31. In other words, the Sn—Cu diffusion layer 32 covers the base electrode layer 31. When the Sn—Cu diffusion layer 32 covers the base electrode layer 31, it is possible to reduce or prevent the entry of hydrogen to the multilayer body 12, so it is possible to reduce or prevent the degradation of insulation resistance.

The Sn—Cu diffusion layer 32 includes tin (Sn) and copper (Cu). More specifically, in the Sn—Cu diffusion layer 32, Cu is diffused in Sn. The content of Sn in the Sn—Cu diffusion layer 32 of the present example embodiment is higher than the content of Cu in the Sn—Cu diffusion layer 32. The Sn—Cu diffusion layer 32 of the present example embodiment is a region in which the content of Cu is higher than or equal to about 10%, for example. Specifically, the cross section of the outer electrode 30 in the lamination direction X and the length direction Z (for example, the cross section when the multilayer ceramic capacitor 10 is ground in the width direction Y up to half the dimension in the width direction Y) will be subjected to line analysis using a scanning electron microscope (SEM) made by JEOL Ltd. (model number: JSM-7800F) under a magnification of 10,000 times. The X-ray spectra of Cu and Sn at this time are measured, and the ratio of Cu and Sn is measured from the intensities of the measured spectra, and the region in which the content of Cu is higher than or equal to about 10% is defined as the Sn—Cu diffusion layer 32, for example.

As shown in FIG. 5, gaps P are provided at the interface between the base electrode layer 31 and the Sn—Cu diffusion layer 32. The situation in which the gaps P are provided at the interface between the base electrode layer 31 and the Sn—Cu diffusion layer 32 is a state where the gaps P are in contact with the base electrode layer 31 and the Sn—Cu diffusion layer 32. When the gaps P are provided at the interface between the base electrode layer 31 and the Sn—Cu diffusion layer 32, it is possible to trap moisture in the gaps P, so it is possible to improve moisture resistance reliability. Furthermore, the porosity of the gaps P is preferably higher than or equal to about 0.18 and lower than or equal to about 2.0%, and the porosity is more preferably higher than or equal to about 0.4% and lower than or equal to about 0.6%, for example. By setting the described range, it is possible to sufficiently trap moisture in the gaps P and reduce or prevent a decrease in mechanical strength caused by the gaps P.

The porosity is calculated by binarizing an image into a metal portion and a gap portion using image processing software (such as GIMP). The image is obtained when the cross section in the lamination direction X and the length direction Z (for example, the cross section when the multilayer ceramic capacitor 10 is ground in the width direction Y up to half the dimension in the width direction Y) is measured with a scanning electron microscope (SEM) made by JEOL Ltd. (model number: JSM-7800F) under the conditions of a magnification of 7,000 times. For example, the ratio of the area occupied by the gaps P to the area occupied by the base electrode layer 31 and the Sn—Cu diffusion layer 32 in the field of view including the interface between the base electrode layer 31 and the Sn—Cu diffusion layer 32 is calculated as porosity.

The thickness of the Sn—Cu diffusion layer 32 is preferably greater than or equal to about 0.1 μm and less than or equal to about 0.5 μm, for example.

The Sn—Ni diffusion layer 33 of the present example embodiment is provided on the outer side of the Sn—Cu diffusion layer 32. In other words, the Sn—Ni diffusion layer 33 covers the Sn—Cu diffusion layer 32.

The Sn—Ni diffusion layer 33 includes tin (Sn) and nickel (Ni). More specifically, in the Sn—Ni diffusion layer 33, Ni is diffused in Sn. The content of Sn in the Sn—Ni diffusion layer 33 of the present example embodiment is higher than the content of Ni in the Sn—Ni diffusion layer 33. The Sn—Ni diffusion layer 33 of the present example embodiment is a region in which the content of Ni is higher than or equal to about 10%, for example. Specifically, the cross section of the outer electrode 30 in the lamination direction X and the length direction Z (for example, the cross section when the multilayer ceramic capacitor 10 is ground in the width direction Y up to half the dimension in the width direction Y) will be subjected to line analysis using the SEM made by JEOL Ltd. under a magnification of 10,000 times. The X-ray spectra of Ni and Sn at this time are measured, and the ratio of Ni and Sn is measured from the intensities of the measured spectra, and the region in which the content of Ni is higher than or equal to about 10%, for example, is defined as the Sn—Ni diffusion layer 33.

The thickness of the Sn—Cu diffusion layer 32 is thicker than the thickness of the Sn—Ni diffusion layer 33. When the thickness of the Sn—Cu diffusion layer 32, which has a greater stress relaxation effect than the Sn—Ni diffusion layer 33, is increased, it is possible to improve the mechanical strength.

An intermediate Sn plating layer 36 of which the content of Sn is higher than or equal to about 90% is provided between the Sn—Cu diffusion layer 32 and the Sn—Ni diffusion layer 33. The thickness of the intermediate Sn plating layer 36 is preferably greater than or equal to about 1.0 μm and less than or equal to about 5.0 μm, for example. When the thickness of the intermediate Sn plating layer 36 is greater than or equal to about 1.0 μm and less than or equal to about 5.0 μm, for example, the intermediate Sn plating layer 36 can effectively function as a barrier layer to block the entry of moisture.

The Ni plating layer 34 is provided on the Sn—Ni diffusion layer 33. In other words, the Ni plating layer 34 covers the Sn—Ni diffusion layer 33. The main component of the Ni plating layer 34 is Ni. In the Ni plating layer 34 of the present example embodiment, the content of Ni is higher than or equal to about 90%, for example.

The Sn plating layer 35 is provided on the Ni plating layer 34. In other words, the Sn plating layer 35 covers the Ni plating layer 34. Furthermore, in other words, the Sn plating layer 35 is the outermost layer of the outer electrode 30. The main component of the Sn plating layer 35 is Sn. In the Sn plating layer 35 of the present example embodiment, the content of Sn is higher than or equal to about 90%, for example.

### Advantageous Effects

With the multilayer ceramic capacitor 10 according to the present example embodiment, the following advantageous effects are obtained.

When the gaps P are provided at the interface between the base electrode layer 31 and the Sn—Cu diffusion layer 32, it is possible to trap moisture in the gaps P, so it is possible to reduce or prevent the degradation of insulation resistance.

By setting the porosity of the gaps P to higher than or equal to about 0.1% and lower than or equal to about 2.0%, or further to higher than or equal to about 0.4% and lower than or equal to about 0.6%, for example, it is possible to sufficiently trap moisture in the gaps P and reduce or minimize a decrease in mechanical strength caused by the gaps P.

The thickness of the Sn—Cu diffusion layer 32 is thicker than the thickness of the Sn—Ni diffusion layer 33. When the thickness of the Sn—Cu diffusion layer 32, which has a greater stress relaxation effect than the Sn—Ni diffusion layer 33, is increased, it is possible to improve the mechanical strength.

The intermediate Sn plating layer 36 of which the content of Sn is higher than or equal to about 90%, for example, is provided between the Sn—Cu diffusion layer 32 and the Sn—Ni diffusion layer 33. Thus, the intermediate Sn plating layer 36 functions as a barrier layer to block the entry of moisture, with the result that it is possible to reduce or prevent the deterioration of insulation resistance of the multilayer ceramic capacitor 10.

### Second Example Embodiment

Hereinafter, a multilayer ceramic capacitor according to the second example embodiment of the present disclosure will be described. The multilayer ceramic capacitor according to the second example embodiment has a similar configuration to the multilayer ceramic capacitor according to the first example embodiment except for the shape and placement of the inner electrodes and the number and configuration of the outer electrodes. Like reference signs denote the same or similar components to those of the first example embodiment in the second example embodiment, and the detailed description thereof is omitted.

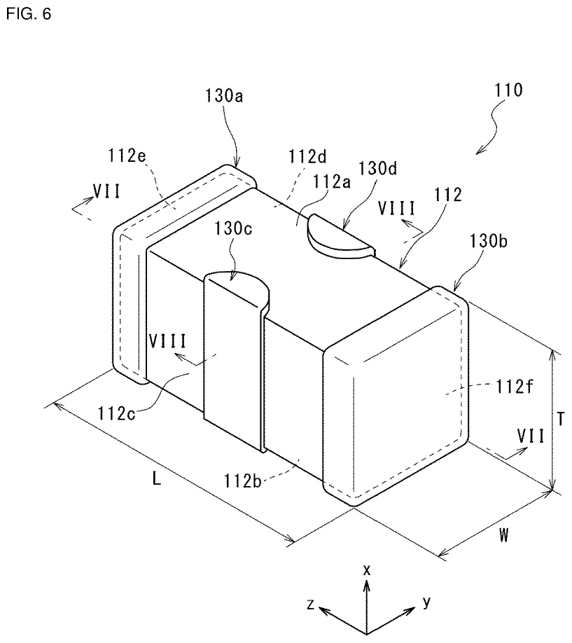

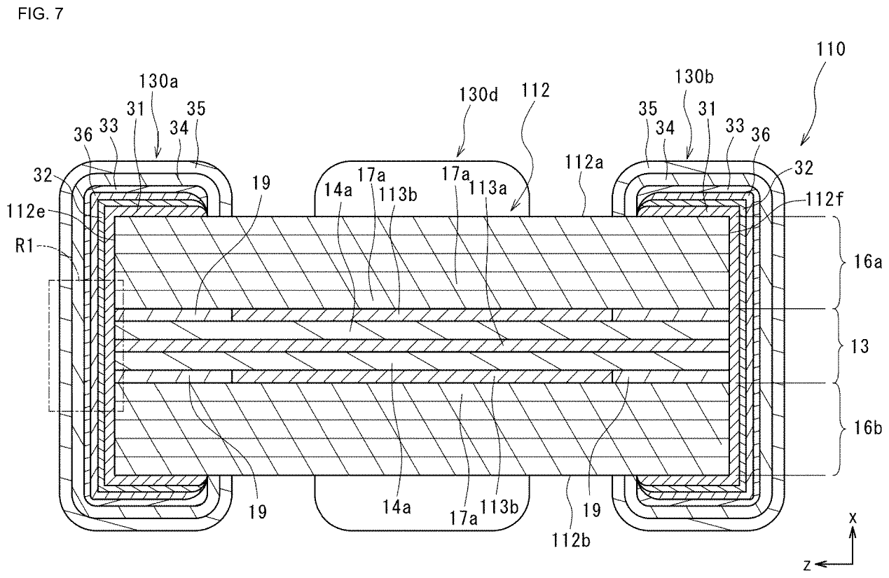

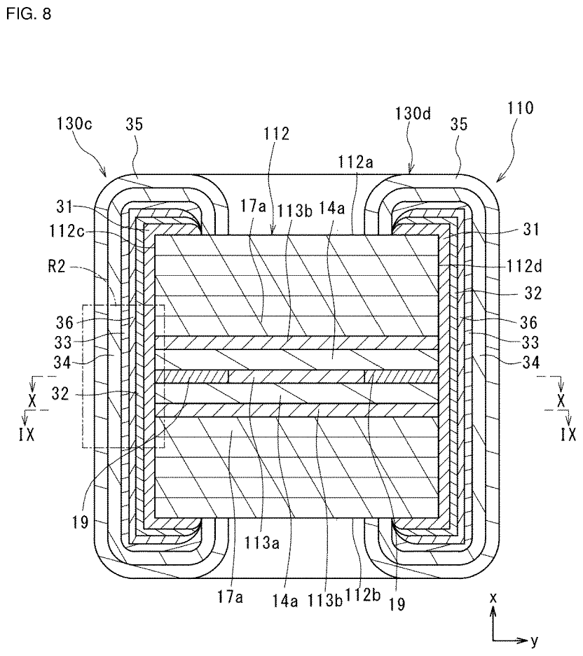

FIG. 6 is a perspective view of a multilayer ceramic capacitor 110 according to the present example embodiment. FIG. 7 is a cross-sectional view taken along the line VII-VII in FIG. 6. FIG. 8 is a cross-sectional view taken along the line VIII-VIII in FIG. 6.

Referring to FIG. 6, the multilayer ceramic capacitor 110 of the present example embodiment includes a multilayer body 112, a first outer electrode 130a, a second outer electrode 130b, a third outer electrode 130c, and a fourth outer electrode 130d. In the following description, if there is no need to specifically distinguish the four outer electrodes 130a, 130b, 130c, 130d from one another, one of the four outer electrodes 130a, 130b, 130c, 130d may simply be referred to as outer electrode 130. The multilayer ceramic capacitor 110 according to the present example embodiment is an example of the multilayer electronic component.

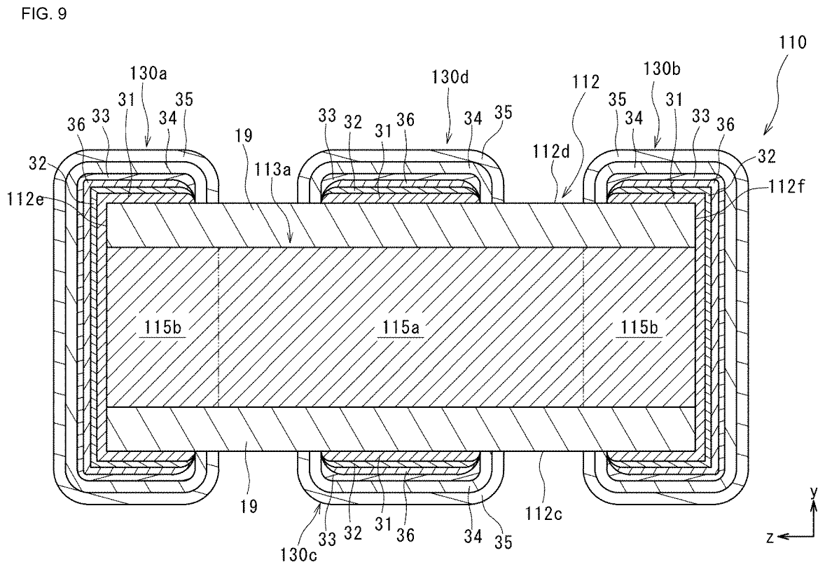

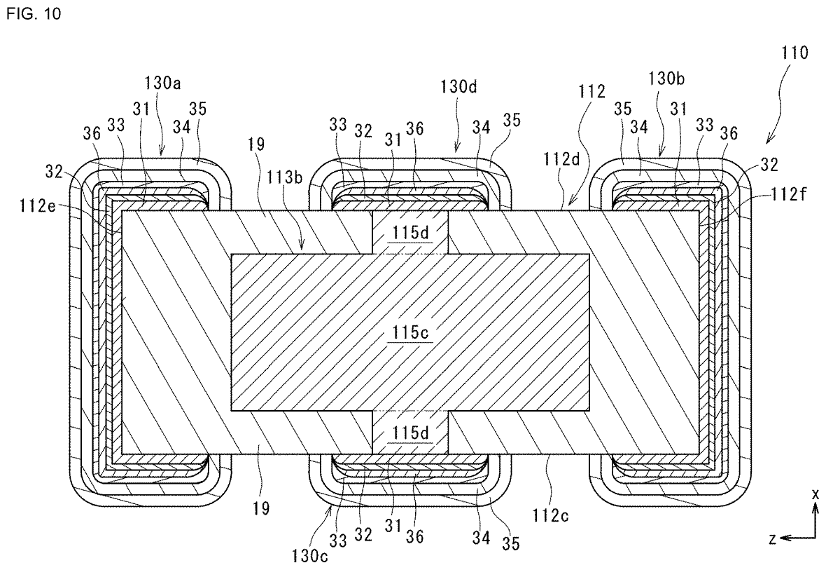

Referring to FIGS. 7, 8, 9, and 10, the inner electrodes of the present example embodiment include a first inner electrode 113a including an end portion located at a fifth surface 112e and an end portion located at a sixth surface 112f, and second inner electrodes 113b each including an end portion located at a third surface 112c and an end portion located at a fourth surface 112d. As shown in FIG. 9, the first inner electrode 113a includes a counter electrode portion 115a and two extended electrode portions 115b. Each of the extended electrode portions 115b is exposed at the fifth surface 112e or the sixth surface 112f. As shown in FIG. 10, the second inner electrode 113b includes a counter electrode portion 115c and two extended electrode portions 115d. Each extended electrode portion 115d is exposed at the third surface 112c or the fourth surface 112d. The extended electrode portion 115b and the counter electrode portion 115a shown in FIG. 9 are substantially equal in the dimension in the width direction Y to each other. However, the dimension in the width direction Y of the extended electrode portion 115b may narrow as it approaches the closest one of the fifth surface 112e and the sixth surface 112f. The first inner electrode 113a and the second inner electrode 113b extend across the inner dielectric layer 14a in the lamination direction X.

The outer electrodes 130 are respectively provided at four sides of the multilayer body 112 when the multilayer body 112 is viewed in the lamination direction X. Each of the first outer electrode 130a and the second outer electrode 130b covers a portion of a first surface 112a, a portion of a second surface 112b, part of the third surface 112c, a portion of the fourth surface 112d, and the fifth surface 112e or the sixth surface 112f, of the multilayer body 112. The first outer electrode 130a and the second outer electrode 130b are electrically connected to the first inner electrode 113a shown in FIG. 9. Each of the third outer electrode 130c and the fourth outer electrode 130d covers a portion of the first surface 112a, a portion of the second surface 112b, and the third surface 112c or the fourth surface 112d, of the multilayer body 112. The third outer electrode 130c and the fourth outer electrode 130d are electrically connected to the second inner electrodes 113b shown in FIG. 10.

The outer electrode 130 has a similar configuration to the outer electrode 30 according to the first example embodiment. The outer electrode 130 includes a base electrode layer 31, an Sn—Cu diffusion layer 32 covering the base electrode layer, an Sn—Ni diffusion layer 33 on the outer side of the Sn—Cu diffusion layer 32, an Ni plating layer 34 on the Sn—Ni diffusion layer 33, and an Sn plating layer 35, as shown in FIGS. 7, 8, 9, and 10. The base electrode layers 31 of the first outer electrode 130a and the second outer electrode 130b are examples of the base electrode layer, and the base electrode layers 31 of the third outer electrode 130c and the fourth outer electrode 130d are examples of the second base electrode layer. The Sn—Cu diffusion layers 32 of the first outer electrode 130a and the second outer electrode 130b are examples of the Sn—Cu diffusion layer, and the Sn—Cu diffusion layers 32 of the third outer electrode 130c and the fourth outer electrode 130d are examples of the second Sn—Cu diffusion layer. The Sn—Ni diffusion layers 33 of the first outer electrode 130a and the second outer electrode 130b are examples of the Sn—Ni diffusion layer, and the Sn—Ni diffusion layers 33 of the third outer electrode 130c and the fourth outer electrode 130d are examples of the second Sn—Ni diffusion layer. The Ni plating layers 34 of the first outer electrode 130a and the second outer electrode 130b are examples of the Ni plating layer, and the Ni plating layers 34 of the third outer electrode 130c and the fourth outer electrode 130d are examples of the second Ni plating layer. The Sn plating layers 35 of the first outer electrode 130a and the second outer electrode 130b are examples of the Sn plating layer, and the Sn plating layers 35 of the third outer electrode 130c and the fourth outer electrode 130d are examples of the second Sn plating layer.

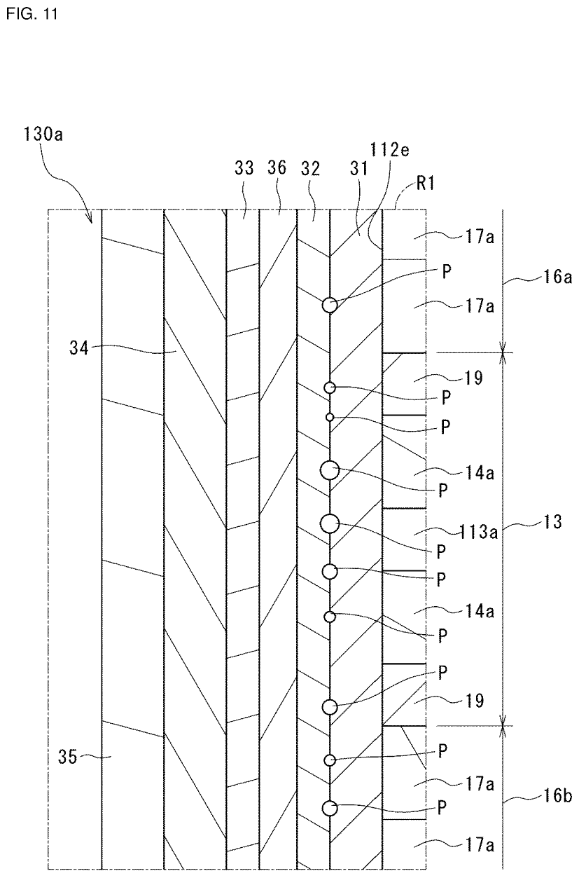

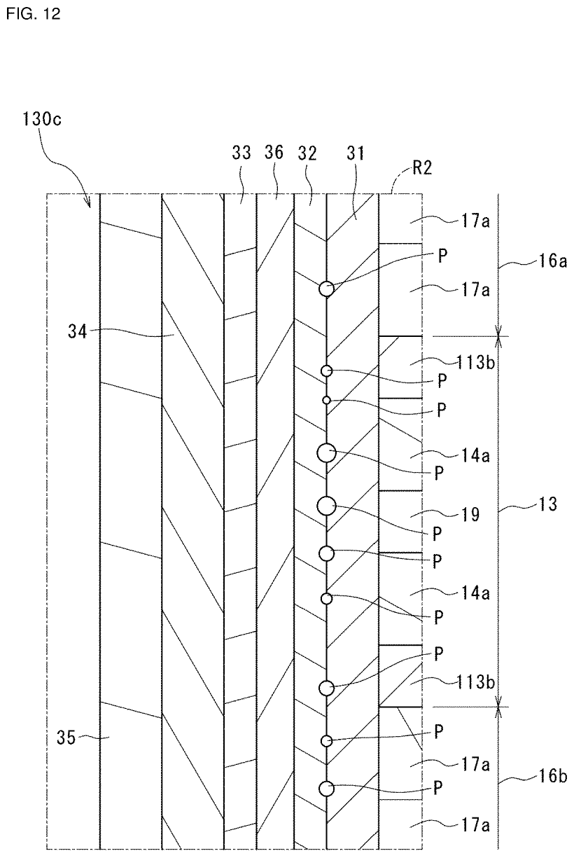

As shown in FIGS. 11 and 12, gaps P are provided at the interface between the base electrode layer 31 and the Sn—Cu diffusion layer 32. The situation in which the gaps P are provided at the interface between the base electrode layer 31 and the Sn—Cu diffusion layer 32 is a state where the gaps P are in contact with the base electrode layer 31 and the Sn—Cu diffusion layer 32. The gaps P of the first outer electrode 130a and the second outer electrode 130b are examples of the gap, and the gaps P of the third outer electrode 130c and the fourth outer electrode 130d are examples of the second gap.

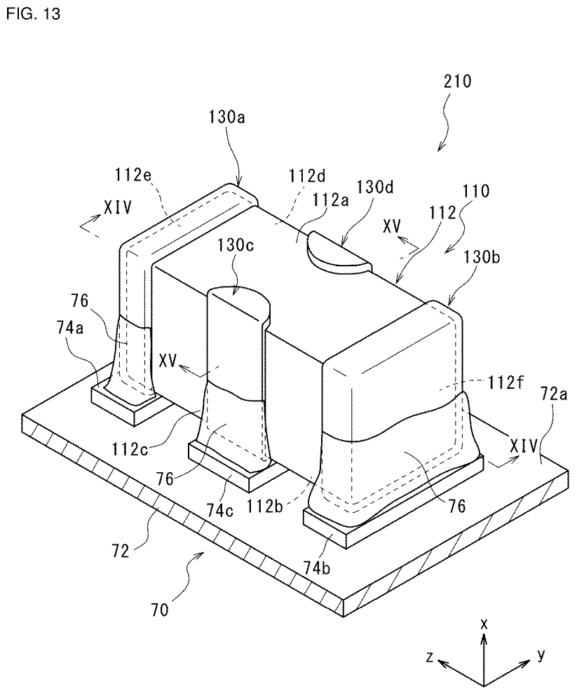

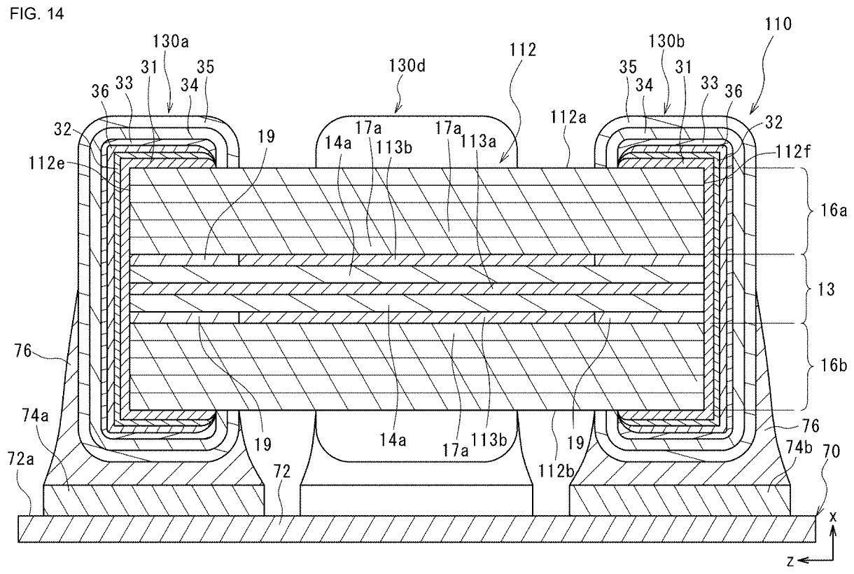

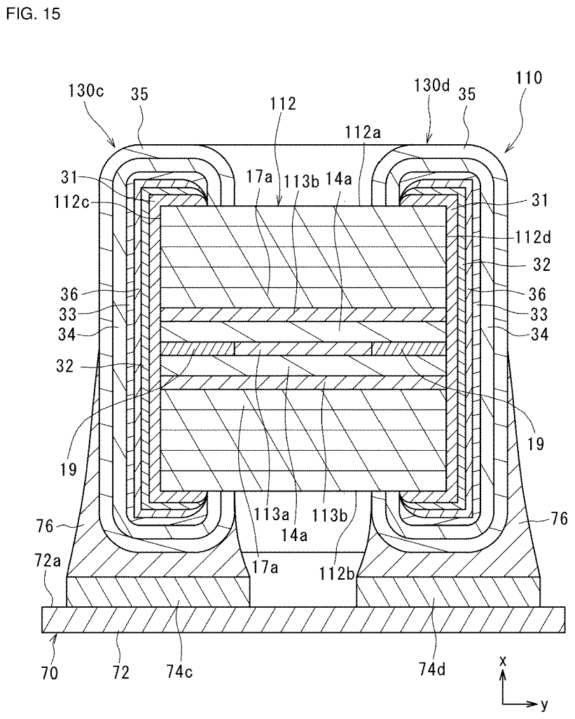

FIG. 13 is a perspective view that shows a mounting structure for a multilayer electronic component according to the present example embodiment. FIG. 14 is a cross-sectional view taken along the line XIV-XIV in FIG. 13. FIG. 15 is a cross-sectional view taken along the line XV-XV in FIG. 13.

A mounting structure 210 for the multilayer ceramic capacitor according to the present example embodiment includes the multilayer ceramic capacitor 110 according to the present example embodiment and a mounting substrate 70, as shown in FIGS. 13 to 15. The mounting substrate 70 includes a substrate core material 72 and conductor lands (connection conductors) 74 on a substrate-side mounting surface 72a of the substrate core material 72.

A first conductor land 74a is electrically connected and mechanically joined to the first outer electrode 130a of the multilayer ceramic capacitor 110 by a bonding material 76. A second conductor land 74b is electrically connected and mechanically joined to the second outer electrode 130b of the multilayer ceramic capacitor 110 by a bonding material 76. A third conductor land 74c is electrically connected and mechanically joined to the third outer electrode 130c of the multilayer ceramic capacitor 110 by a bonding material 76. A fourth conductor land 74d is electrically connected and mechanically joined to the fourth outer electrode 130d of the multilayer ceramic capacitor 110 by a bonding material 76.

The conductor lands 74 may be provided on a principal surface of the substrate core material 72, opposite from the substrate-side mounting surface 72a.

The material of the conductor land 74 is not specifically limited, and, for example, metals, such as Cu, Au, Pd, or Pt, may be used. The thickness, that is, the dimension in the lamination direction X, of the conductor land 74 is not particularly limited and is preferably, for example, greater than or equal to about 20 μm and less than or equal to about 200 μm. For example, a high-temperature resistant epoxy-based adhesive agent or a solder may be used as the bonding material 76.

In the above description, the mounting substrate 70 corresponds to a mounting substrate. However, the connection conductor is not limited by other applications, functions, shapes, names, and the like as long as the connection conductor is, other than a so-called land, a conductor that is provided between the multilayer electronic capacitor 110 and the mounting substrate 70 and can electrically connect the multilayer electronic capacitor 110 and the mounting substrate 70.

In the present example embodiment, each of the four outer electrodes 130a, 130b, 130c, 130d has the above-described configuration, that is, a similar configuration to the outer electrode 30 according to the first example embodiment. However, the configuration is not limited thereto. Two outer electrodes 130 provided at facing positions of the four outer electrodes 130a, 130b, 130c, 130d may have the above-described configuration. Only the first outer electrode 130a and the second outer electrode 130b may have the above-described configuration, or only the third outer electrode 130c and the fourth outer electrode 130d may have the above-described configuration.

In the multilayer ceramic capacitor 110 of the second example embodiment, when the configuration of the outer electrode 30 of the multilayer ceramic capacitor 10 according to the first example embodiment is applied to the outer electrodes 130 to which a positive potential is applied, among the four outer electrodes 130a, 130b, 130c, 130d, similar operation and advantageous effects to those of the multilayer ceramic capacitor 10 according to the first example embodiment are obtained. For the first outer electrode 130a and the second outer electrode 130b, when the configuration of the outer electrode 30 of the multilayer ceramic capacitor 10 according to the first example embodiment is applied to all the four outer electrodes 130a, 130b, 130c, 130d, similar operation and advantageous effects to those of the multilayer ceramic capacitor 10 according to the first example embodiment are obtained.

### 2. Manufacturing Method for Multilayer Ceramic Capacitor

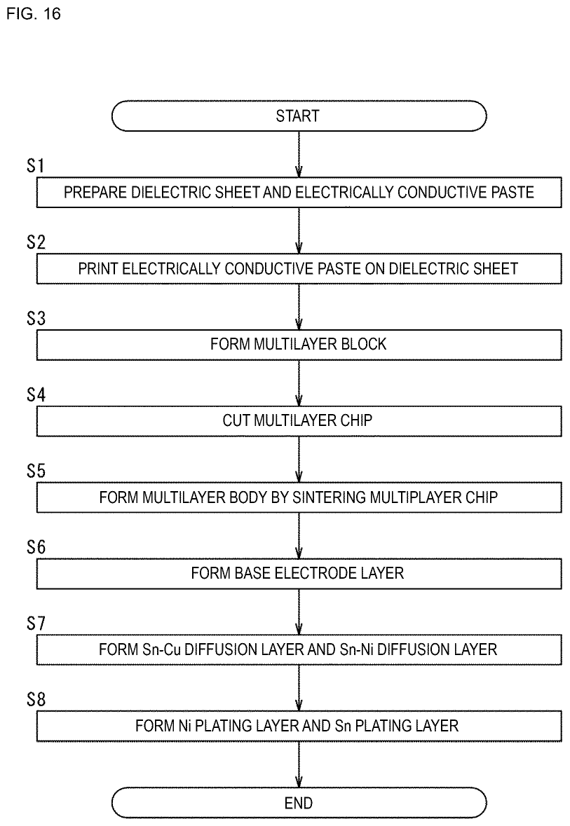

Hereinafter, a non-limiting example of a manufacturing method for a multilayer ceramic capacitor will be described with reference to FIG. 16. FIG. 16 is a flowchart for illustrating a manufacturing method for a multilayer ceramic capacitor. In the following description, a manufacturing method for the multilayer ceramic capacitor according to the first example embodiment will be, for example, described. The multilayer ceramic capacitor 110 according to the second example embodiment can be manufactured with a similar manufacturing method to the manufacturing method for the multilayer ceramic capacitor 10 according to the first example embodiment.

In step S1, dielectric sheets, an electrically conductive paste for inner electrodes, and an electrically conductive paste for outer electrodes are prepared. The dielectric sheet, the electrically conductive paste for inner electrodes, and the electrically conductive paste for outer electrodes include binders and solvents.

In step S2, by printing with the electrically conductive paste for inner electrodes onto the dielectric sheet in a predetermined pattern, a dielectric sheet for an inner layer portion, in which an inner electrode pattern of the inner layer portion 13 is printed on the dielectric sheet, is formed. Printing with the electrically conductive paste for inner electrodes onto the dielectric sheet may be performed by, for example, screen printing or gravure printing.

In step S3, the dielectric sheet and the dielectric sheet for inner electrodes are laminated and pressed in a lamination direction by, for example, isostatic press to form a multilayer block.

In step S4, a multilayer chip is cut by cutting the multilayer block to a predetermined size. After that, corner portions and ridge portions of the multilayer chip may be rounded by barrel polishing or the like.

In step S5, the multilayer body 12 according to the present example embodiment is formed by firing the multilayer chip in an air atmosphere.

In step S6, an electrically conductive paste for an outer electrode including glass components and Cu is applied to the fifth surface 12e and the sixth surface 12f by, for example, dipping or a method of applying an electrically conductive paste by extruding the electrically conductive paste through a slit plate. After that, the base electrode layer 31 is formed through sintering process.

In step S7, the Sn—Cu diffusion layer 32 and the Sn—Ni diffusion layer 33 are formed. Specifically, an Sn plating is formed on the base electrode layer 31, an Ni plating is formed on the Sn plating, and heat treatment is performed at a temperature higher than or equal to the melting point of the Sn plating, with the result that the Sn plating diffuses in the base electrode layer 31 and the Ni plating. Electrolytic plating is preferably used as a plating process. Barrel plating is preferably used as a plating method. Thus, Sn is diffused in Cu in the base electrode layer 31 to form the Sn—Cu diffusion layer 32, and the Sn—Ni diffusion layer 33 and the Ni plating layer 34 are formed. At this time, gaps P are formed at the interface between the base electrode layer 31 and the Sn—Cu diffusion layer 32. By controlling the temperature or time of heat treatment, it is possible to control the porosity and the thicknesses of the Sn—Cu diffusion layer 32 and the Sn—Ni diffusion layer 33. By controlling the thickness of the Sn plating formed on the Ni plating as well, it is possible to control the thicknesses of the Sn—Cu diffusion layer 32 and the Sn—Ni diffusion layer 33. At this time, the region in which Cu and Ni are not diffused is defined as intermediate Sn plating layer 36.

In step S8, the Ni plating layer 34 and the Sn plating layer 35 are formed. Electrolytic plating is preferably used as a plating process. Barrel plating is preferably used as a plating method. At this time. when the Ni plating layer 34 is formed in step S7, only the Sn plating layer 35 may be formed.

When four outer electrodes are provided on the multilayer body 112 as in the case of the second example embodiment, the base electrode layers 31 are provided on the third surface to the sixth surface in step S6. In step S7, by selectively forming the Sn—Cu diffusion layer 32 and the Sn—Ni diffusion layer 33 on the third surface 12c to the sixth surface 12f, the outer electrode 30 can be formed on a desired surface.

As described above, the example embodiments of the present disclosure have been described in the specification. However, the present disclosure is not limited thereto. Various modifications may be added to the example embodiments described above in terms of mechanism, shape, material, number, position, arrangement, or the like without departing from the scope of the present disclosure, and the present disclosure encompasses those modifications.

In an example, the step layers 19 are provided in the same planes as the inner electrodes 13a in FIGS. 2, 3, and 4. However, the step layers 19 do not need to be provided in the same planes as the inner electrodes 13a. The step layers 19 are provided in the same plane as the inner electrode 113a in FIGS. 7 to 10. However, the step layers 19 do not need to be provided in the same plane as the inner electrode 113a. In other words, the step layers 19 do not need to be provided in the inner layer portion 13.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer electronic component comprising:
a multilayer body including a first surface and a second surface opposite each other in a lamination direction, a third surface and a fourth surface opposite each other in a first direction orthogonal to the lamination direction, and a fifth surface and a sixth surface opposite each other in a second direction orthogonal to the lamination direction and the first direction;
a first outer electrode on the fifth surface of the multilayer body; and
a second outer electrode on the sixth surface of the multilayer body; wherein
the multilayer body includes:
an inner dielectric layer; and
an inner electrode laminated on the inner dielectric layer in the lamination direction;
the first outer electrode includes:
a base electrode layer on the fifth surface and connected to the inner electrode;
an Sn—Cu diffusion layer on the base electrode layer and including tin and copper;
an Sn—Ni diffusion layer on an outer side of the Sn—Cu diffusion layer and including tin and nickel; and
an Ni plating layer on the Sn—Ni diffusion layer and including nickel as a main component; and
a gap is located at an interface between the base electrode layer and the Sn—Cu diffusion layer.

2. The multilayer electronic component according to claim 1, wherein an Sn plating layer is located between the Sn—Cu diffusion layer and the Sn—Ni diffusion layer.

3. The multilayer electronic component according to claim 1, wherein a thickness of the Sn—Cu diffusion layer is greater than a thickness of the Sn—Ni diffusion layer.

4. The multilayer electronic component according to claim 1, further comprising:
a third outer electrode on the third surface of the multilayer body; and
a fourth outer electrode on the fourth surface of the multilayer body.

5. The multilayer electronic component according to claim 4, wherein
the multilayer body includes a second inner electrode laminated on the inner dielectric layer in the lamination direction and including an end portion located at the third surface;
the third outer electrode includes:
a second base electrode layer on the third surface and connected to the second inner electrode;
a second Sn—Cu diffusion layer on the second base electrode layer and including tin and copper;
a second Sn—Ni diffusion layer on an outer side of the second Sn—Cu diffusion layer and including tin and nickel; and
a second Ni plating layer on the second Sn—Ni diffusion layer and including nickel as a main component; and
a second gap is located at an interface between the second base electrode layer and the second Sn—Cu diffusion layer.

6. The multilayer electronic component according to claim 1, wherein the multilayer electronic component is a multilayer ceramic capacitor.

7. The multilayer electronic component according to claim 1, further comprising a step layer located in a same plane as the inner electrode.

8. The multilayer electronic component according to claim 1, wherein the Sn—Cu diffusion layer covers an entirety of the base electrode layer.

9. The multilayer electronic component according to claim 1, wherein the Sn—Cu diffusion layer includes more Sn than Cu.

10. The multilayer electronic component according to claim 1, wherein a porosity of the gap is higher than or equal to about 0.1% and lower than or equal to about 2.0%.

11. The multilayer electronic component according to claim 1, wherein a porosity of the gap is higher than or equal to about 0.4% and lower than or equal to about 0.6%.

12. The multilayer electronic component according to claim 1, wherein a plurality of the gap is provided at interface between the base electrode layer and the Sn—Cu diffusion layer.

13. The multilayer electronic component according to claim 1, wherein a thickness of the Sn—Cu diffusion layer is greater than or equal to about 0.1 μm and less than or equal to about 0.5 μm.

14. The multilayer electronic component according to claim 1, wherein the Sn—Ni diffusion layer covers an entirety of the Sn—Cu diffusion layer.

15. The multilayer electronic component according to claim 2, wherein a thickness of the Sn plating layer is greater than or equal to about 1.0 μm and less than or equal to about 5.0 μm.

16. The multilayer electronic component according to claim 2, wherein the Sn plating layer has a content of Sn equal to or greater than about 90%.

17. The multilayer electronic component according to claim 5, wherein a plurality of the second gap is provided at the interface between the second base electrode layer and the second Sn—Cu diffusion layer.

18. A mounting structure for a multilayer electronic component, the mounting structure comprising:
the multilayer electronic component according to claim 1; and
a mounting substrate on which the multilayer electronic component is mounted; wherein
a positive potential is applied to the first outer electrode and the second outer electrode.

19. The mounting structure according to claim 18, wherein the multilayer electronic component further includes:
a third outer electrode on the third surface of the multilayer body; and
a fourth outer electrode on the fourth surface of the multilayer body.

20. The mounting structure according to claim 18, wherein
the multilayer body includes a second inner electrode laminated on the inner dielectric layer in the lamination direction and including an end portion located at the third surface;
the third outer electrode includes:
a second base electrode layer on the third surface and connected to the second inner electrode;
a second Sn—Cu diffusion layer on the second base electrode layer and including tin and copper;
a second Sn—Ni diffusion layer on an outer side of the second Sn—Cu diffusion layer and including tin and nickel; and
a second Ni plating layer on the second Sn—Ni diffusion layer and including nickel as a main component; and
a second gap is located at an interface between the second base electrode layer and the second Sn—Cu diffusion layer.
